(19) United States
(12) Patent Application Publication
(10) Pub. No.: US 2007/0006963 A1
(43) Pub. Date: Jan. 11, 2007

(54) Continuous self-laminating labels

(76) Inventor: Mario V. Bever, Evergem (BE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/558,619

(22) PCT Filed: May 28, 2004
(86) PCT No.: PCT/EP04/05811

§ 371 Date: Aug. 11, 2006

(30) Foreign Application Priority Data
May 28, 2003 (GB) 0312214.0

(51) Int. Cl. B32B 37/12; B32B 37/00; B32B 38/14; B32B 7/12; B41J 11/00; G09F 3/02; B32B 7/06; B32B 38/04

(52) U.S. Cl. 156/213; 156/227; 156/250; 156/184; 156/192; 156/268; 156/277; 156/280; 156/249; 428/41.8; 400/611

(57) ABSTRACT

The invention provides a roll of tape for use in a tape printing apparatus for producing labels. In use an unprinted portion of the tape overlays a printed portion of the tape thereby forming a laminated label. The tape comprises a layer of label material, a layer of removable liner material. The tape comprises at least one fold with the tape being folded back on itself in a width-wise direction, the tape having first and second overlapping portions. The first portion has an outer surface arranged for printing thereon.

The present invention relates to self-laminating labels. The invention is particularly suitable for self-laminating labels for wire and cable identification.

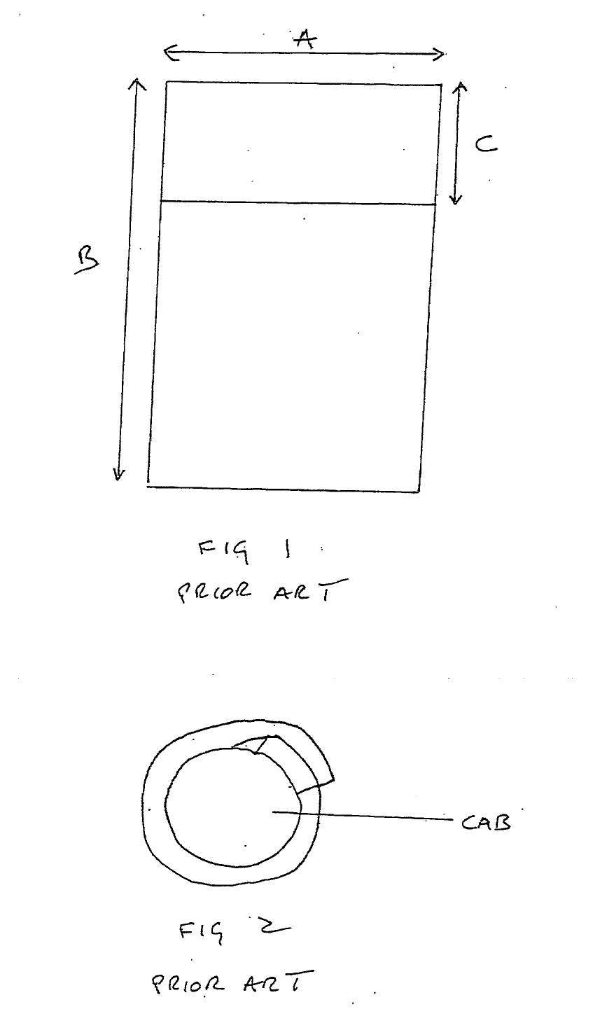

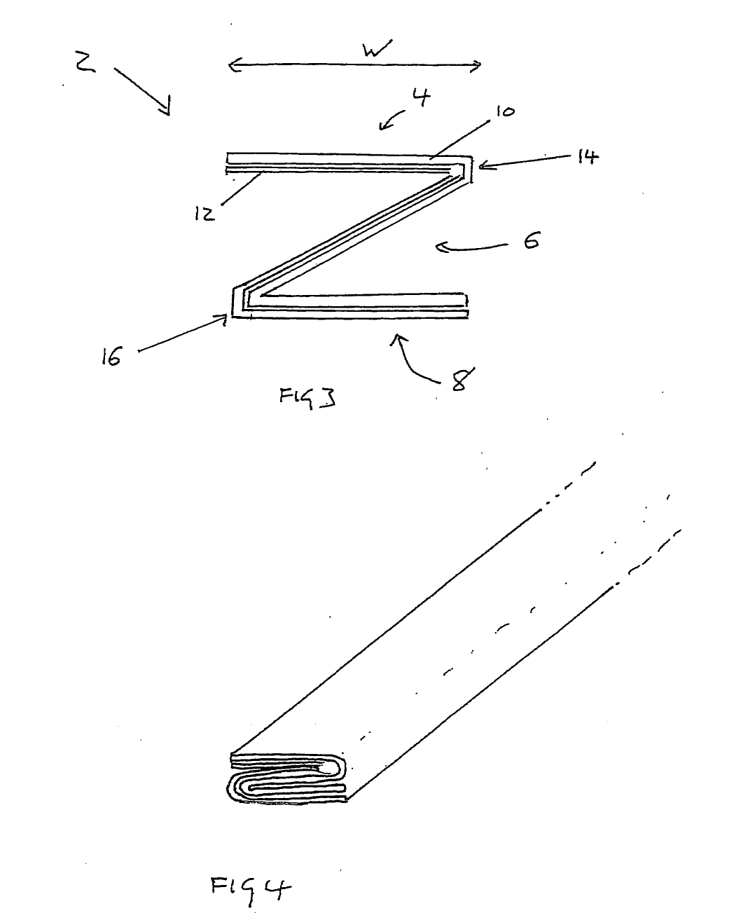

Self-laminating labels are commonly made from a transparent flexible vinyl or PET film, with a pressure sensitive adhesive. A schematic diagram of a known self-laminating labels is shown in FIG. 1. Self-laminating labels generally have a rectangular shape of which the upper half or upper third of the length is ink coated (area AC), which is used to print the cable's identification on (referred to as the “write-on” zone). The remaining transparent half or two thirds is used to wrap around the cable (CAB) and to over laminate the printed area as shown in FIG. 2. The total length of the label (B) should be at least the outside circumference of the cable+the height of the printable area. The height of the transparent zone should be at least the outside circumference of the cable. The height of the printable area should be less than the outside circumference of the cable.

Self-laminating labels have always been commercialised as die-cut labels. Depending on the type of printer to be used, self-laminating labels may be presented on roll format, separate sheets or fanfold label stock.

As discussed above, the write-on zone of conventional self-laminating labels have clearly defined dimensions. Accordingly, the amount of text that can be printed on a label is limited. For identification, and in particular, where a large amount of information is required, large labels are needed. However, large die-cut labels do not fit into small hand-held portable printers. In particular, these cassette systems have a limited maximum tape width that they can accept.

It is an aim of the embodiments of the present invention to solve the above-mentioned problems. In particular, some embodiments of the present invention may provide a solution to the problem of mounting a wide self-laminating label tape into a narrow cassette for use in a tape printer to produce self-laminating labels. Embodiments of the present invention may provide self-laminating labels on a continuous ribbon of material, presented on a roll format, and mounted into a printer cassette system.

According to a first aspect of the present invention, there is provided a tape supply for use in a tape printing apparatus for producing self-laminating labels, said tape supply comprising a roll of tape, said tape comprising a first layer of adhesive label material and a second layer of removable liner material, wherein said tape comprises at least one fold with the tape being folded back on itself in a width-wise direction thus having first and second overlapping portions, and an outer surface of said first portion comprises said label material for printing thereon.

According to a second aspect of the present invention, there is provided a tape supply for use in a tape printing apparatus for producing self-laminating labels, said tape supply comprising a roll of tape, said tape comprising a label layer, a liner layer, and an adhesive layer disposed therebetween, said label layer comprising a clear material and said liner layer comprising a removable layer of a clear or a non-clear material.

According to a third aspect of the present invention, there is provided a tape printer comprising a tape supply receiving portion for receiving a supply of tape, a print head comprising a plurality of printing elements for printing an image on a tape, a drive means for driving a tape past the print head, a cutting mechanism, and a control means, said control means being adapted to control the plurality of printing elements, the drive means and the cutting mechanism to produce a self-laminating label having a print portion and a tail portion.

According to a fourth aspect of the present invention there is provided a self-laminating label comprising a label layer, a liner layer, and an adhesive layer disposed therebetween, said label having a lead portion, a print portion, and a tail portion, wherein said label layer comprises a clear material having print thereon in said print portion and said liner layer comprises a non-clear material, said liner layer being removable from at least said lead and said tail portions.

For a better understanding of the present invention and as to how the same may be carried into effect, reference will now be made by way of example only, to the accompanying drawings in which:

FIG. 1 shows a front view of a prior art self-laminating label;

FIG. 2 shows a cross-sectional view of the prior art self-laminating label shown in FIG. 1 wrapped around a cable;

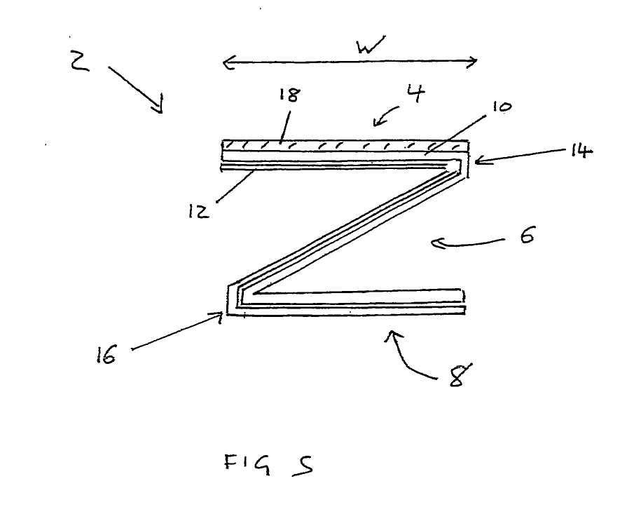

FIG. 3 shows a schematic cross-sectional view of a first embodiment of a tape according to the present invention;

FIG. 4 shows a perspective view of the embodiment of FIG. 3 in continuous format;

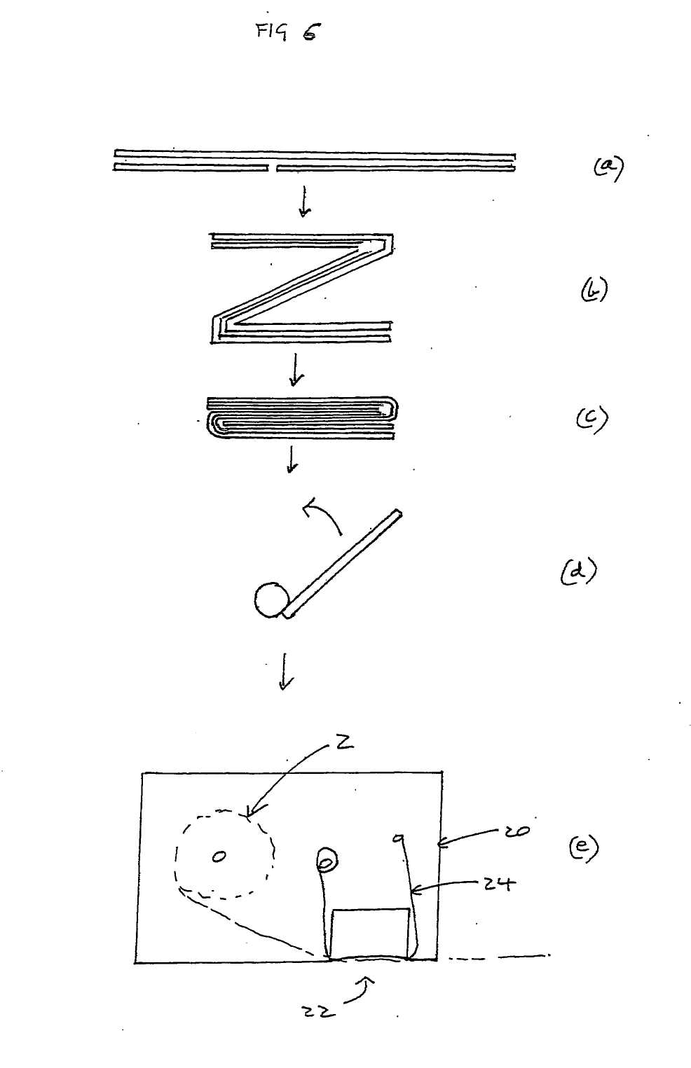

FIG. 5 shows a schematic cross-sectional view of an embodiment of a tape having an ink coating;

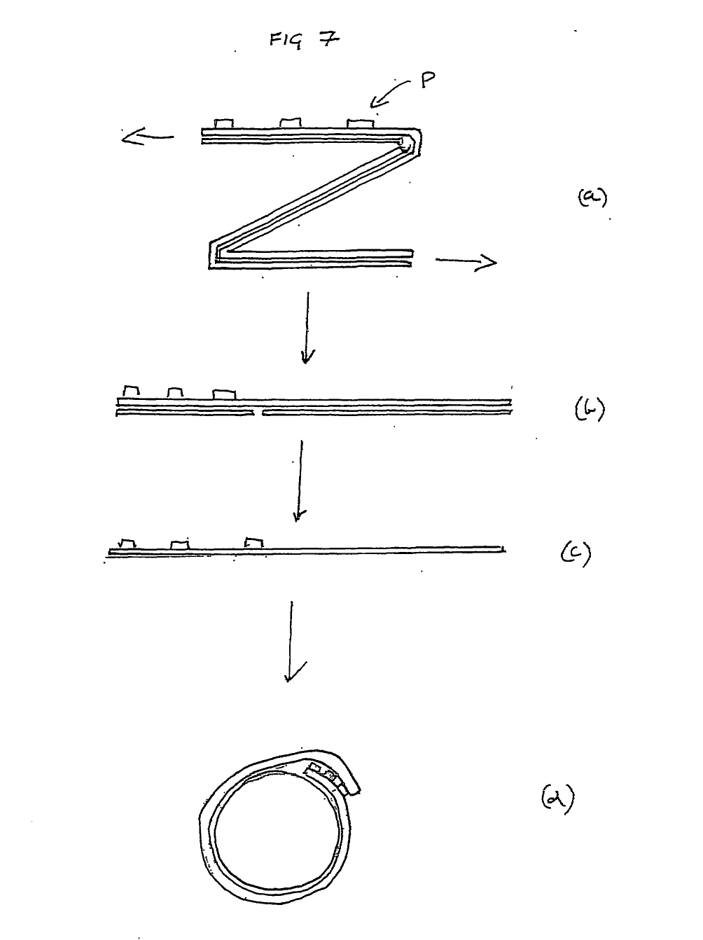

FIG. 6 shows a flow diagram illustrating the steps in the manufacture of an embodiment of a tape cassette according to the present invention;

FIG. 7 shows a flow diagram illustrating the method of applying a printed self-laminating label to a cable;

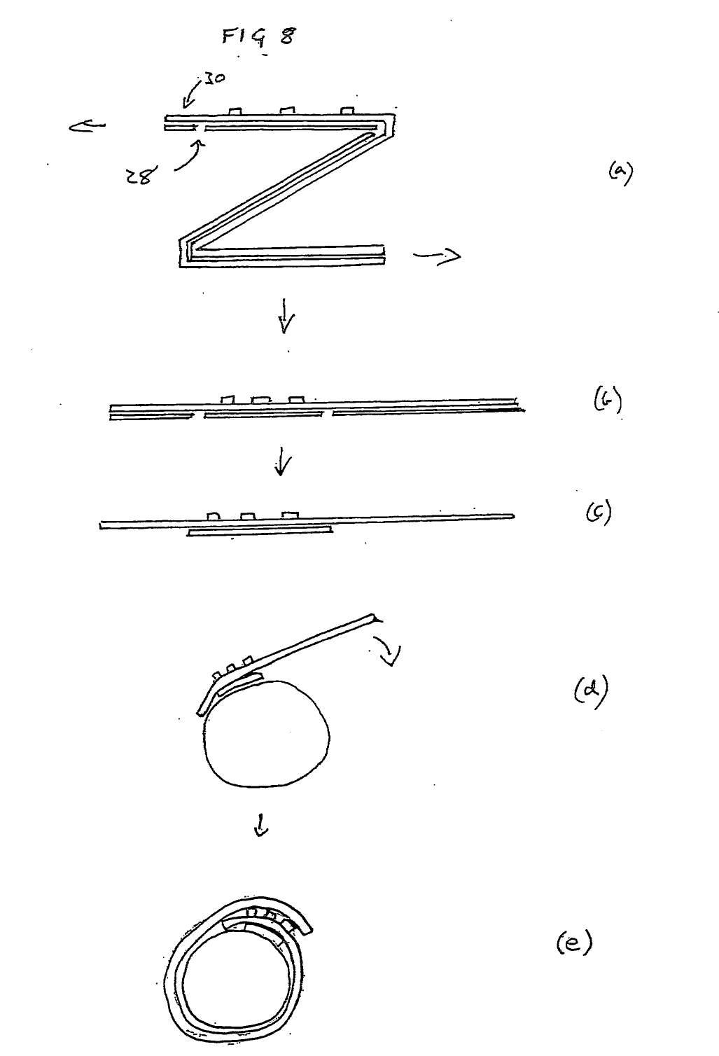

FIG. 8 shows a flow diagram illustrating the method of applying a second embodiment of a label according to the present invention;

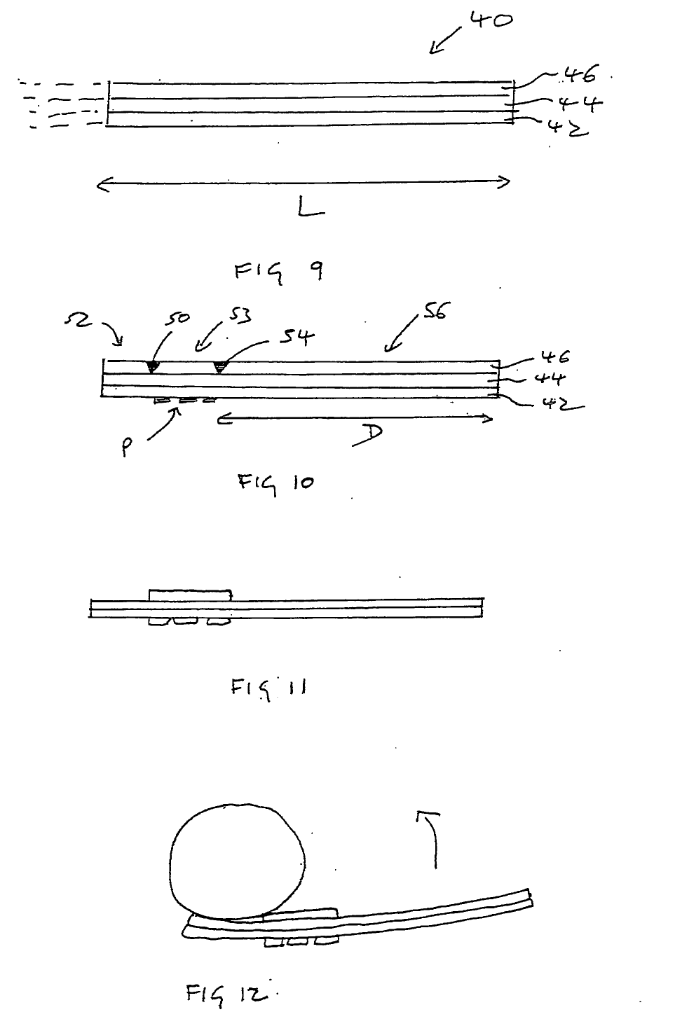

FIG. 9 shows a cross-sectional view another embodiment of a self-laminating label tape according to the present invention;

FIG. 10 shows a cross-sectional view of a self-laminating label produced using the tape of FIG. 9;

FIG. 11 shows the label of FIG. 10 with portions of the backing liner removed;

FIG. 12 shows the label of FIGS. 10 and 11 being wrapped around a cable;

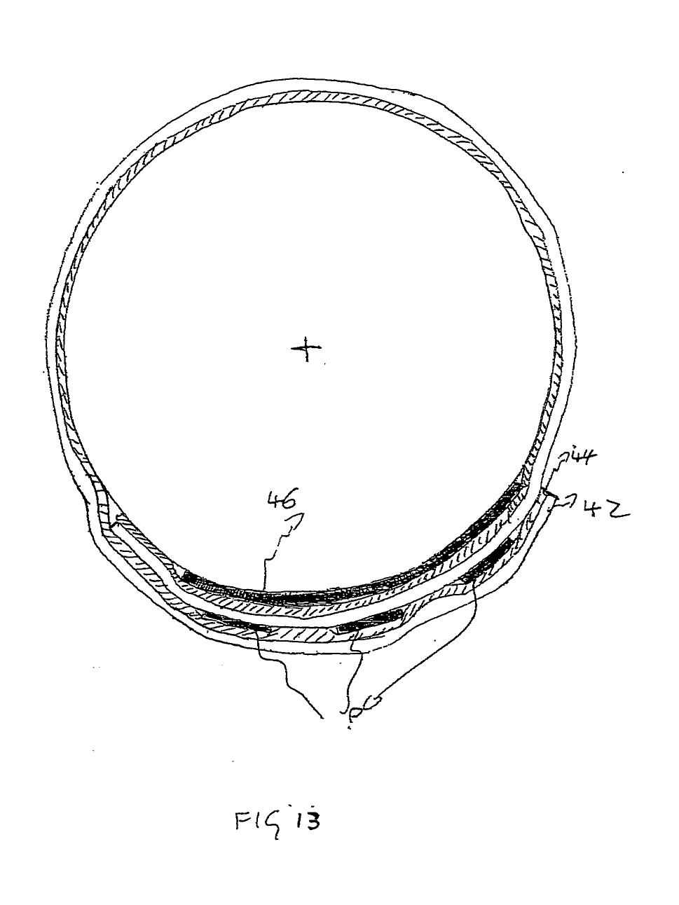

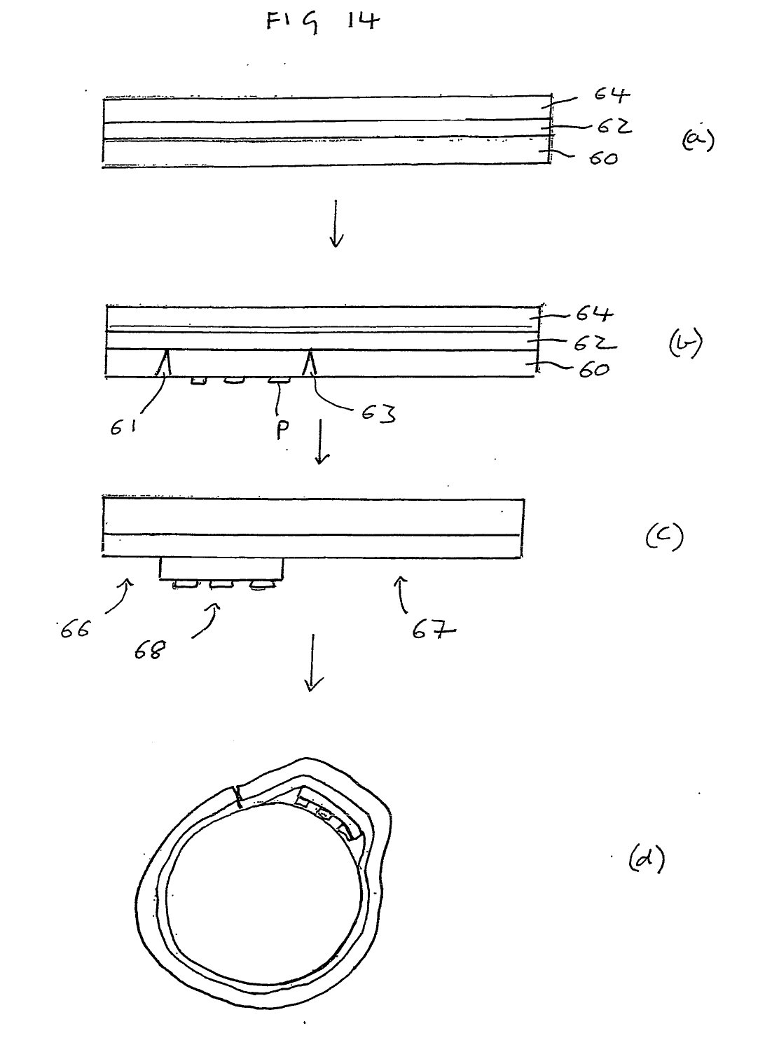

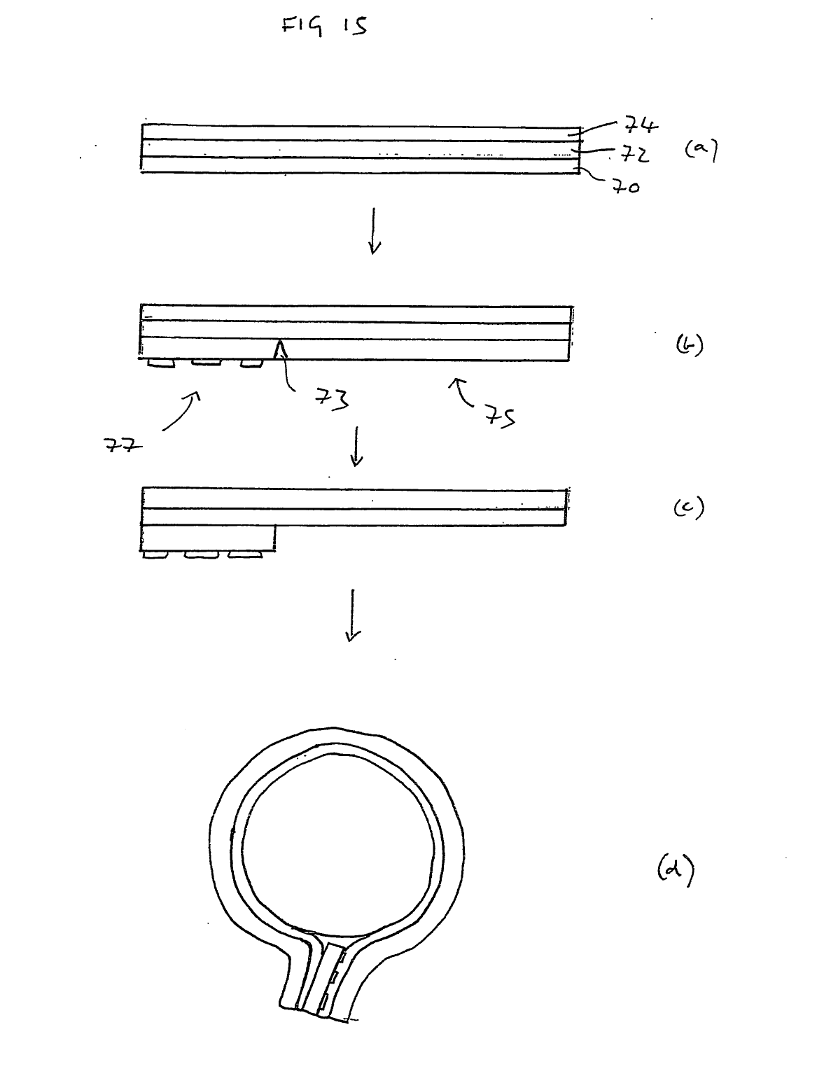

FIG. 13 shows the label of FIGS. 10-11 wrapped around a cable;

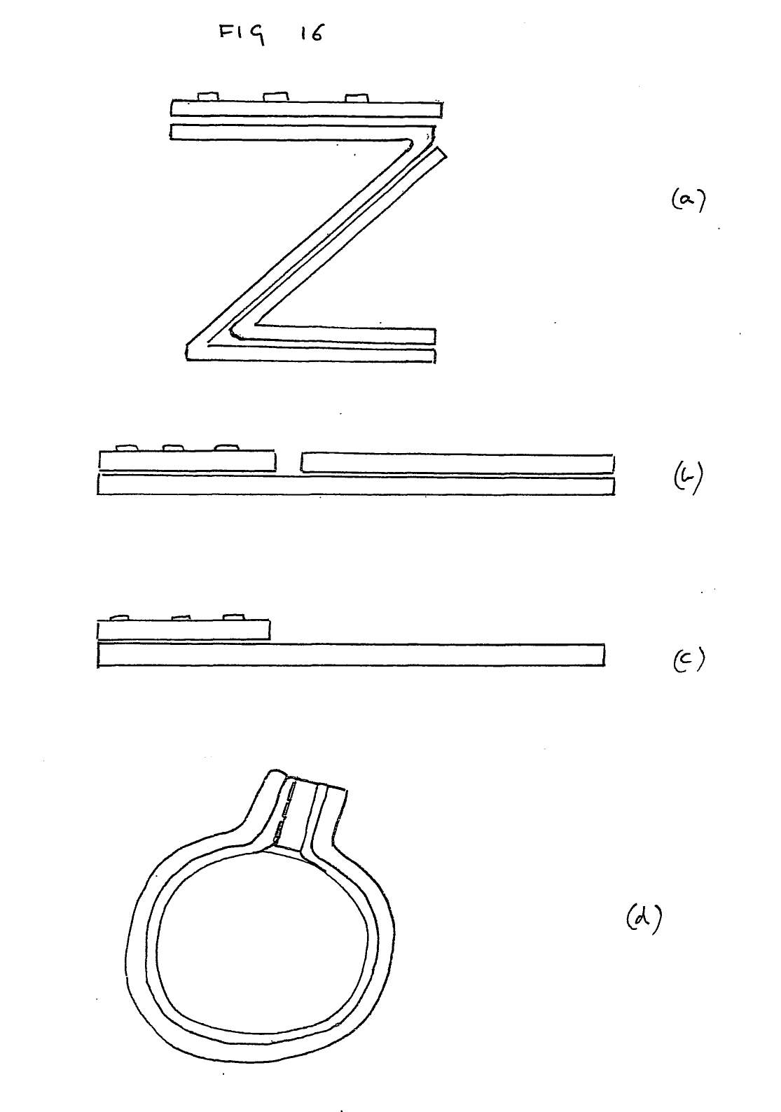

FIG. 14 shows a flow diagram illustrating the method of applying another embodiment of a printed self-laminating label to a cable;

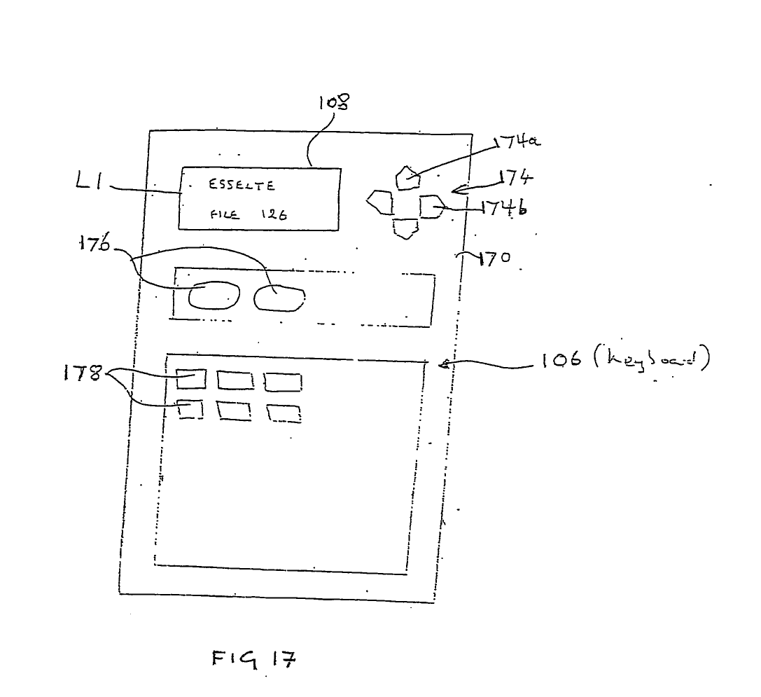

FIG. 15 shows a flow diagram illustrating the method of applying another embodiment of a printed self-laminating label to a cable;

FIG. 16 shows a flow diagram illustrating the method of applying another embodiment of a printed self-laminating label to a cable;

FIG. 17 shows a schematic diagram of the front part of the casing of a printing device;

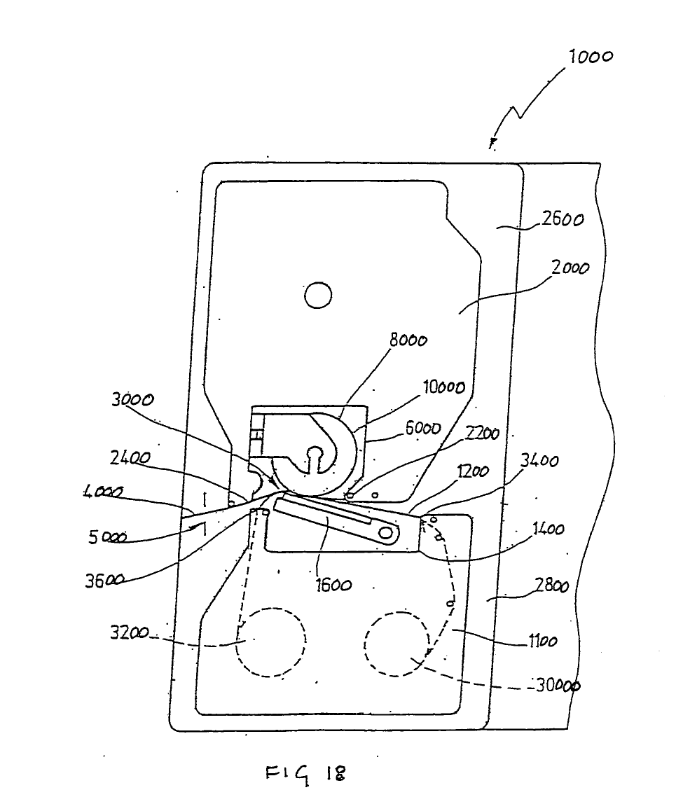

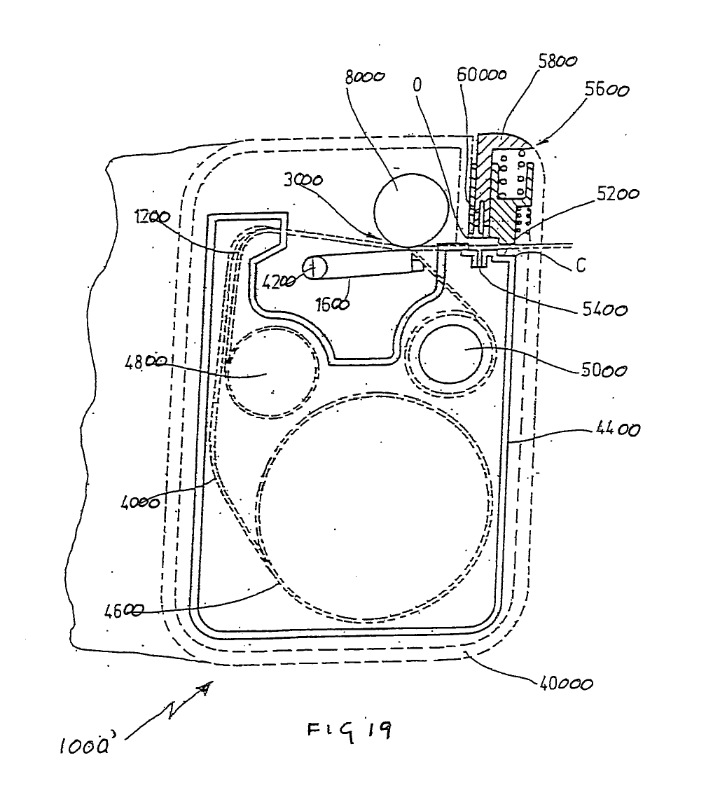

FIG. 18 shows a plan view of a first tape printing device embodying the present invention using a two cassette system;

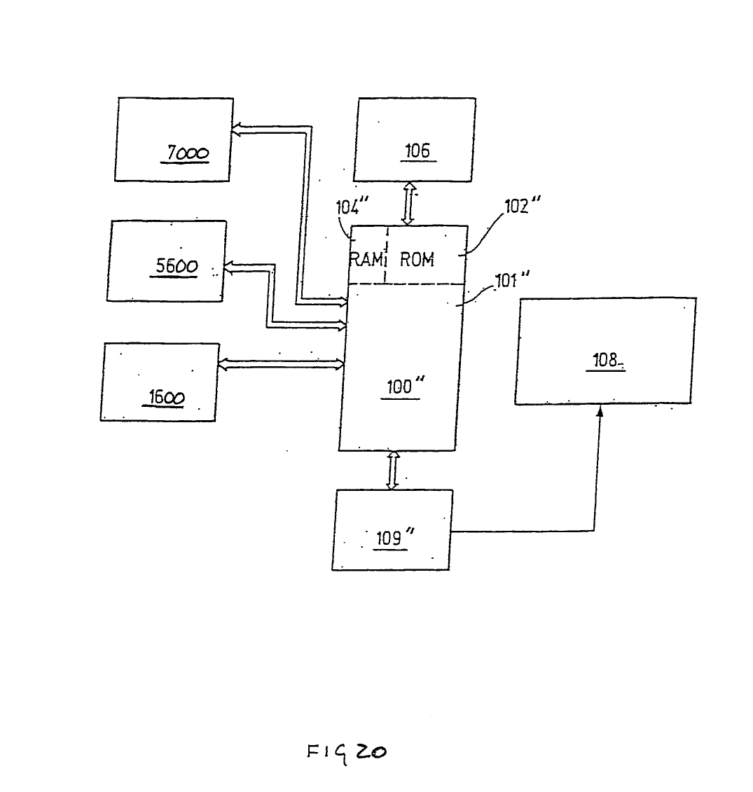

FIG. 19 shows a plan view of a second tape printing device embodying the present invention using a one cassette system;

FIG. 20 shows a diagrammatic sketch showing the control circuitry for the printing device of FIG. 18 or of FIG. 19;

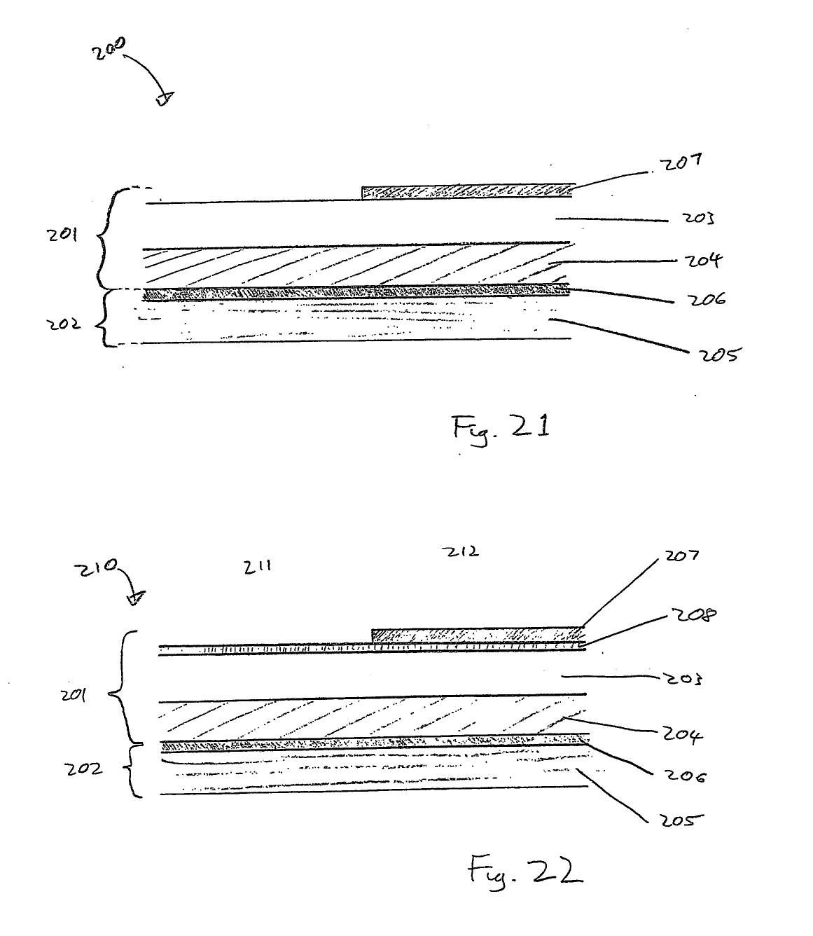

FIG. 21 shows a lateral cross section of a label foil;

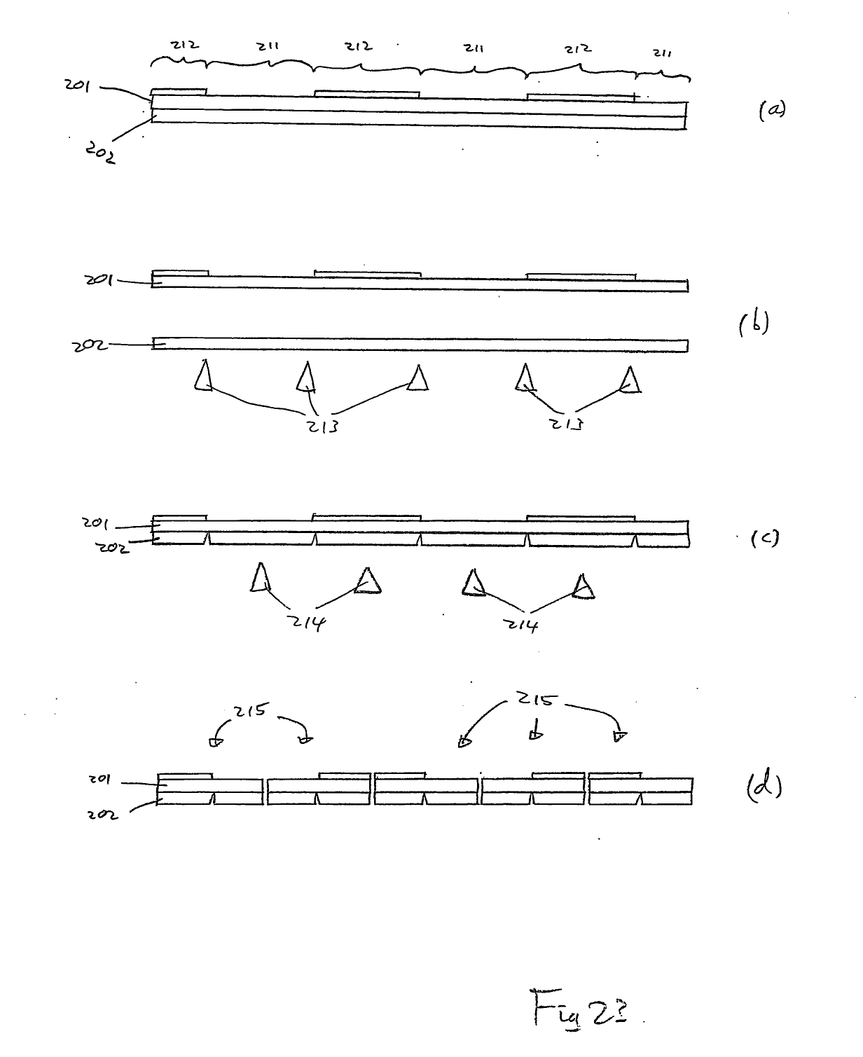

FIG. 22 shows a lateral cross section of an alternative label foil;

FIGS. 23 (a) to (d) show 4 stages in the process of producing a self laminating label tape;

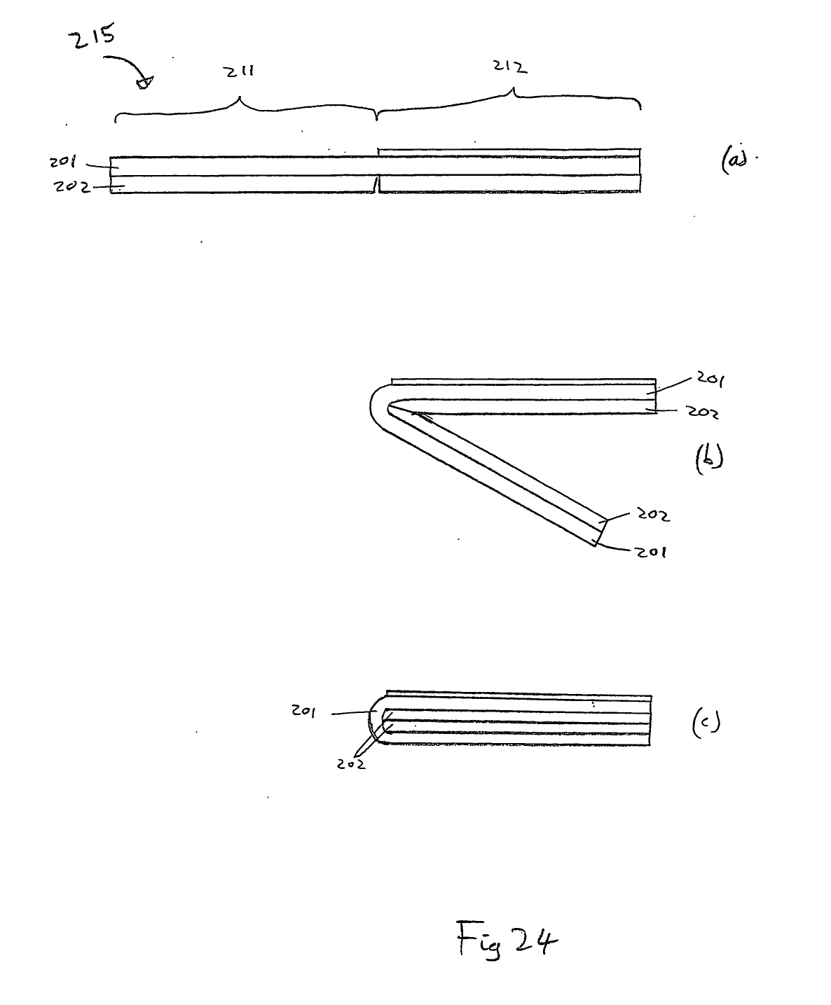

FIGS. 24 (a) to (c) show a further stage in the process of producing a self laminating label tape.

FIG. 3 shows a schematic diagram of an embodiment of a self-laminating label tape in accordance with the present invention. The tape is shown in cross-section along the width (W) of the tape. The tape is folded along its width so as to provide multiple layers which extend over the whole length of the tape as illustrated in FIG. 4. In the illustrated embodiment, the tape is folded into a Z-form, having three portions of equal width, although other folding arrangements are also possible. For example, the tape may comprise more or less than three folded portions. In one embodiment the tape is folded once so as to comprise two overlapping portions having a V-form. In other embodiments, the folded portions may have different widths. The tape may be folded another ways, where three portions are provided. For example, the middle portion may provide the exposed surface on which an image is printed.

The tape 2 in FIGS. 3 and 4 comprises three portions 4, 6, 8 folded back on each other into a Z-form. The tape 2 comprises a label material 10 on which an image may be printed and a liner material 12. The label material comprises a transparent material and more preferably a clear material e.g. a clear PVC (Polyvinyl Chloride) material. The liner material may comprise of a coloured or non-coloured material and may be transparent or opaque e.g. a clear or coloured PET (Polyethylene Terephthalate) material. The label material may be a self adhesive material. Alternatively, a separate layer of an adhesive material is disposed between the label material and the liner material. Thus, the label material will be adhered to the liner material, the liner material being such that it can easily be removed from the label material. The label material can then be adhered to a surface, cable wire or the like when the liner material is removed. Print may be printed on the label material of the first portion. The first portion is one of the end portions. Print may be applied to an upper surface of the label material of the first portion by a thermal transfer printer. Alternatively, the label material may be a direct thermal printing media for direct thermal printing where no ink supply is required.

The material choice for the label and for the liner may be important. The label will be wound round a wire or cable of which the diameter can be as small as 2 mm. Therefore, the label material needs to be very thin, very flexible, and coated with a high performance adhesive to prevent de-lamination after applying to the wire. The label material may be between 1 to 200 microns thick and more preferably between 50 and 100 microns thick. Typically, the label material used in one embodiment of this invention is an 80-micron matt transparent vinyl film. The label material is coated with an adhesive. The adhesive material may be between 1 and 100 microns thick, more preferably between 10 and 40 microns thick and more preferably still between 20 and 30 microns thick. Typically, the label material is coated with a 25 micron pressure sensitive acrylic high tack adhesive (Flexmark V320 TC348 V344).

In embodiments of this invention, the liner material not only serves as a masking material to prevent the adhesive from sticking to the next layer of label material. It has a certain ‘stiffness’ (memory effect) that prevents the Z- or V-form from opening after flattening along the slitting lines. On top of that, it needs to be thin in order to keep the 3-fold construction thin enough to be transportable in the cassette system and the printer mechanism. The liner material may be between 1 and 200 microns thick, more preferably between 10 and 50 microns thick, and more preferably still between 20 and 30 microns thick. Typically, the liner material of this invention may be a 23 micron PETP/C (PET polymer/copolymer) film. The PET may be a homo-polymer or a co-polymer.

The self-adhesive label material 10 of the first, second and third portions 4, 6, 8 forms a single, continuous, material being folded at the interface 14 between the first and second portions 4, 6 and at the interface 16 between the second and third portions 6, 8. The liner material of the first, second and third portions may form a single continuous material, or alternatively, may comprise plural sections. In particular, the liner material may be slit at the positions where the folds are applied so as to aid in the folding and flattening of the tape. In the illustrated embodiment, the liner has a slit at the first interface between the first and second portions. This not only aids in folding the tape, but also allows the liner material of the three portions to be removed. A further improvement includes incorporating a slit in the liner of the first portion so as to define a lead portion. This will also be discussed later. In yet another embodiment, the label material has a coloured and a clear zone. Such an embodiment is shown in FIG. 5, which shows a tape having an ink coating 18 on the first portion of the tape thereby defining a coloured zone which is printed. The coloured zone may be defined in any other way in alternative embodiments of the invention. The coloured zone (and/or alternatively an opaque zone) provides a background for the print thereby improving the clarity of the print. The colour may be selected so as to maximize the clarity of the print. In one embodiment the liner may be completely removed to attach the label to a wire or cable. In other embodiments of the invention, part of the liner may remain attached to the label material. The part of the liner which remains attached may provide a background for the print thereby improving the clarity of the print. The colour/opacity of the liner material may be selected so as to maximize the clarity of the print.

In order to achieve a continuous tape of folded multi-layer material, suitable for coiling and transporting the cassette systems, the folds may be flattened in different ways:

(a) slitting the liner at positions where the folds are to be applied;

(b) using a liner material with a high memory effect;

(c) locally heating the material where the folds are to be applied;

(d) using increased pressure;

(e) using very thin materials;

(f) a combination of two or more of the above solutions.

FIG. 6 shows a flow diagram illustrating the steps involves in manufacturing a cassette including the above-described self-laminating label tape for use in a label printer. The manufacturing process involves the steps of: (a) constructing the layered tape; (b) folding the layered tape width-wise along the length of the tape; (c) compressing the folded tape to form a folded multi-layered tape; (d) winding the folded multi-layered tape into a roll (e) incorporating the roll of folded multi-layered tape into a cassette for a label printer. There are several possible cassette options: (1) a single cassette having a direct thermal label material; (2) a cassette having label material and a separate cassette housing an ink ribbon; (3) a single cassette having label material and ink ribbon. In an alternative embodiment, the wound roll is not incorporated into a cassette but rather can be introduced directly into a label printer.

The cassette may be incorporated into a label printer for printing a label. The tape is fed through a print zone 22 in cooperation with an ink ribbon 24 for printing and the printed label is cut from the tape supply using a cutting mechanism. The printed label may then be applied to a cable or wire after removal of the liner portions. It is also possible to use a thermally sensitive material which can be fed through a print zone and printed on without any ink ribbon for printing i.e. direct thermal printing. Alternatively, an ink supply may be used e.g. ink jet printing.

FIG. 7 illustrates the steps involved in applying the printed label to a cable or wire. The label has print P thereon. The method comprises the steps of: (a) pulling the ends of the label so as to separate the folded portions as shown in (b); removing the liner material from the first, second and third portions as shown in (c)—the slit aids in the removal of the liner material; wrapping the label around the wire/cable to adhere the label to the wire/cable and laminate the printed portion as shown in (d). Here, the printed portion P on the first portion of the label material at one end of the label is overlaid with a portion of the third portion at the other end of the label which is not printed. Accordingly, a printed portion at one end of the label is over-laid with an unprinted portion at the other end of the same label thus forming a self-laminating label.

FIG. 8 illustrates the steps involved in applying a modified embodiment which has a slit 28 in the coloured/opaque liner material of the first portion defining a portion 30. The method is generally the same as that outlined above for FIG. 7. However, in step (c) the liner material is removed from the portion 30 as well as from the second and third portions. This is advantageous as in step (d) the portion 30 may be adhered to the wire/cable to prevent slippage as the remainder of the label is wrapped around the wire/cable. A portion of the liner layer is retained such that the printed portion has a liner background as shown in FIG. 8(e). This can improve the clarity of the label as the printed portion will have a clean coloured/opaque background. The colour of the liner material may be selected so as to maximize the clarity of the print on the label layer.

An alternative solution for producing self-laminating labels using a label printer is shown in FIG. 9. In this arrangement, a self-laminating label to be printed extends in a longitudinal direction (L) of the tape 40, rather than in a width-wise direction of the tape as in the previously described example. The tape comprises a first layer 42 having a first side on which printing may be performed. A second layer 44 is provided on a second side of the first layer, said second side being opposite to said first side. A third layer 46 is provided on said second layer opposite to the first layer. The first layer comprises clear PE (Polyethylene), PVC (Polyvinyl Chloride) or PET (Polyethylene Terephthalate), the second layer comprises an adhesive layer and the third layer comprises a coloured PE, PVC or PET layer. The layers may have thicknesses in the ranges disclosed for the previously described embodiments.

The above-described tape may be wound into a roll and incorporated into a cassette for a label printer. The label printer is arranged to produce a label as illustrated in FIG. 10. During printing, the tape is passed through a print zone wherein print (P) is formed on the clear layer 42. Thereafter, the tape is fed to a cutting mechanism. A first partial cut (tab cut) 50 is performed at the beginning of the printed portion (second portion) of the label at a distance of about 5-10 mm from the edge of the label. The first cut may be made at other positions if required. The cut is made in the backing layer 46 (coloured/opaque layer). This first cut 50 defines a first portion 52 between the edge of the label and the printed (second) portion 53. A second partial cut 54 is formed just after the printed portion, also in the backing layer. Finally, a full cut is performed at a distance (D) from the second tab cut forming a third portion 56. The length (D) of the third portion should be at least equal to the circumference of the tube or wire. The length of the second portion (printed portion) should be less than the outside circumference of the cable. Note that a partial cut or tab-cut may be defined as a cut through one or more layers, but not all the layers, of a multilayered tape.

To apply the label, the backing layer of the first portion 52 is removed (from the edge of the beginning of the label to the first tab cut). The backing layer of the third portion 56 is removed (from the edge of the end of the label to the second tab cut). This is illustrated in FIG. 11.

The first portion is applied to the surface of the tube or wire thereby sticking the first portion to the tube or wire as shown in FIG. 12. The remaining portions of the label are wrapped around the tube or wire so as to cover the surface of the tube or wire and cover the printed area with the clear portion of the front face as shown in FIG. 13.

This arrangement is advantageous as the tape can easily be put into standard tape cassettes for tape printers. Accordingly, no special investments are required for production and the tape can immediately be implemented in tape printers. A further advantage is that only one cassette is required to cover a wide range of cable diameters. That is, the length of the label will depend of the positions of the various cuts described above and not on the width of the tape. Accordingly, different length dimensions of the label can be input to the label printer according to the size of the cable to be labelled.

In an alternative embodiment illustrated in FIGS. 14(a) to (d), the partial cuts 61, 63 are made in the label layer 60 rather than the liner layer 64. Portions of the label layer 66, 67 can then be removed on either side of the printed portion 68 having print P thereon to reveal the adhesive layer 62 on the liner layer. The label may then be wrapped around a cable/wire with the liner layer 64 over-laying the printed portion. In this embodiment the characters are preferably mirror printed. The label layer and the liner layer are preferably transparent and more preferably clear. In this embodiment the length of the label may be less than the outside circumference of the cable or wire.

In another embodiment illustrated in FIGS. 15(a) to (d), a single partial cut 73 is made in the label layer 70. A portion 75 of the label layer 70 can then be removed to reveal the adhesive layer 72 on the liner layer 74. The label may then be wrapped around a cable/wire with the liner layer 74 over-laying the printed portion 77. In this embodiment the laminated printed portion extends radially away from the cable/wire. The liner layer is preferably transparent and more preferably clear. The label layer is preferably coloured/opaque. In this embodiment the length of the label is preferably the outside circumference of the cable or wire+the length of the printed portion.

In another embodiment illustrated in FIGS. 16(a) to (d), a single partial cut 83 is provided in the label layer 80 of a tape having a Z-shaped structure similar to that illustrated in FIG. 3. A portion 85 of the label layer 80 can then be removed to reveal the adhesive on the self adhesive liner layer 84. The label may then be wrapped around a cable/wire with the liner layer 84 over-laying the printed portion 87. In this embodiment the laminated printed portion extends radially away from the cable/wire. The liner layer is preferably transparent and more preferably clear. The label layer is preferably coloured/opaque. In this embodiment the length of the label is preferably the outside circumference of the cable or wire+the length of the printed portion.

In a simplified embodiment, no partial cuts are formed and the whole of the backing layer is removed prior to applying the label to a tube or wire. This simplified embodiment has the advantage that no partial cut (tab-cut) mechanism is required. However, this simplified embodiment has the disadvantage that the background to the print area comprises the surface of the tube or wire. Accordingly, the clarity of the print will depend on the nature of the surface of the tube or wire. In particular, the colour of the tube or wire may be critical in determining the clarity of the print. Care in selecting the colour of the print may be important in such a simplified embodiment. For example, if the surface of the tube or wire is white, black printing will appear clearly. However, if the surface of the tube or wire is black, a white or light coloured print may be more appropriate.

In the illustrated embodiment, a portion of the coloured liner is retained as the background to the printed area in an applied label. This arrangement improves the clarity of the label.

In an alternative embodiment, partial cuts (tab-cuts) are pre-formed in the tape supply. This embodiment is advantageous in that no partial cut mechanism is required in the label printer as the partial cuts are pre-formed in the tape supply.

FIG. 17 illustrates the front of an embodiment of a tape printing device. Reference numeral 170 denotes the casework of the printer. The front of the printer carries a liquid crystal display (LCD) 108 and a keyboard 106 having a plurality of cursor control keys 174, a plurality of function keys 176, only two of which are illustrated in FIG. 17, and a plurality of character selecting keys 178, only six of which are illustrated in FIG. 17. The keyboard 106 is used for inputting characters to the tape printing device. This could be achieved with other input means, for example a touch pad or a touch screen. The function keys include a return key, a delete key, an edit key, and a print key amongst others. In alternative embodiments of the invention additional and/or alternative functions may be provided. As is known, combinations of keys can be used in place of individual keys for each function.

The display can display two lines of text. Other embodiments may be able to display more or less than two lines of text. The display is illustrated displaying a two line label (L1) ESSELTE (first line) FILE 126 (second line). As is known, the character selecting keys 178 allow text to be selected by a user to formulate labels to be printed. The term “text” in the following refers to numerals, symbols, icons, background patterns, barcodes and similar as well as characters, which together may make up an image to be printed on a label. The function keys 176 allow different functions to be implemented, and in effect control the operational modes of the printer.

The printer operates with a supply of tape on which images are printed. Lengths of the tape are cut off after a label has been printed. The tape is housed in a cassette which is held in a cassette bay.

Typically, this tape printing device 1000 is a hand held or small desk top device which is powered by batteries at least part of the time. Alternatively or additionally the tape printing device may be supplied with power from a mains supply. In some embodiments, the tape printing device will sometimes be powered by a mains supply and sometimes by batteries.

FIG. 18 shows in plan view, with the outer casing depicted in FIG. 17 removed, the first tape printing device embodying the present invention which has two cassettes arranged therein. The upper cassette 2000 is located in a first cassette receiving portion 2600 and contains a supply of image receiving tape 4000 which passes through a print zone 3000 of the tape printing device 1000 to an outlet 5000 of the tape printing device 1000. The image receiving tape 4000 comprises a layered structure as described earlier. The upper cassette 2000 has a recess for accommodating a platen 8000 of the tape printing device 1000, and guide portions 2200 and 2400 for guiding the tape through the print zone 3000. The platen 8000 is mounted for rotation within a cage moulding 10000. Alternatively, the platen could be mounted for rotation on a pin.

The lower cassette 1100 is located in a second cassette receiving portion 2800 and contains a thermal transfer ribbon 1200 which extends from a supply spool 30000 to a take up spool 3200 within the cassette 1100. The thermal transfer ribbon 1200 extends through the print zone 3000 in overlap with the image receiving tape 4000. The cassette 1100 has a recess 1400 for receiving a print head 1600 of the tape printing device 1000 and guide portions 3400 and 3600 for guiding the thermal transfer ribbon 1200 through the print zone 3000. The print head 1600 is movable between an operative position shown in FIG. 17, in which it is in contact with the platen 8000 and holds the thermal transfer ribbon 1200 and the image receiving tape 4000 in overlap between the print head 1600 and the platen 8000 and in an inoperative position in which it is moved away from the platen 8000 to release the thermal transfer ribbon 1200 and image receiving tape 4000. In the operative position, the platen 8000 is rotated to cause the image receiving tape 1200 to be driven past the print head 1600 and the print head 1600 is controlled to print an image on the image receiving tape 4000 by thermal transfer of ink from the ribbon 1200.

The tape printing device 1000 has a lid which is not shown but which is hinged along the rear of the cassette receiving portions 2600 and 2800 and which covers both cassettes when in place. The lid may of course be hinged to the tape printing device in any other suitable way. In alternative embodiments of the invention, the lid may not be hinged but may be attached to the tape printer, when required, in any other suitable way.

A dc motor 7000 (see FIG. 20) continuously drives the platen 8000. The platen is arranged to drive the image receiving tape 4000 through the print zone 3000 by the actuation of its own rotation.

The image is printed by the print head 1600 on the image receiving tape on a column by column basis with the columns being adjacent one another in the direction of movement of the tape 4000.

FIG. 19 illustrates in plan view a cassette bay of a second printing device 1000′ embodying the present invention which uses a one cassette system. It has its outer casing as depicted in FIG. 17 removed. Like reference numerals are used for those parts which are also shown in FIG. 18. The cassette bay is shown by the dotted line 40000. The cassette bay 40000 includes a thermal print head 1600 and a platen 8000 which cooperate to define a print zone 3000. The thermal print head 1600 is the same as that discussed in relation to FIG. 18.

The print head 1600 is pivotable about a pivot point so that it can be brought into contact with the platen 8000 for printing and moved away from the platen 8000 to enable the cassette to be removed and replaced as in the first embodiment. A cassette inserted into the cassette bay 40000 is denoted generally by reference numeral 4400. The cassette 4400 holds a supply spool 4600 of image receiving tape 4000. The image receiving tape 4000 is guided by a guide mechanism (which is not shown) through the cassette 4400, out of the cassette 4400 through an outlet O past the print zone 3000 to a cutting location C. The same cassette 4400 also has an ink ribbon supply spool 4800 and an ink ribbon take up spool 50000. The ink ribbon 1200 is guided from the ink ribbon supply spool 4800 through the print zone 3000 and taken up on the ink ribbon take up spool 50000. As with the first embodiment, the image receiving tape 4000 passes in overlap with the ink ribbon 1200 through the print zone 3000 with its image receiving layer in contact with the ink ribbon 1200. The platen of this second embodiment is also driven by a motor 7000. The motor rotates to drive the image receiving tape through the print zone 3000 continuously during printing. In either of the embodiments, it is possible that the tape be driven in a step wise manner by a stepper motor. In other embodiments, a different type of motor may be used.

An image is printed on the tape fed out from the print zone to the cutting location C which is provided at a location in a portion of the wall of the cassette 4400 which is close to the print zone 3000. The portion of the wall on the cassette 4400 where the cutting location C is defined is denoted by reference 5200. A slot 5400 is defined in the wall portion 5200 and the image receiving tape 4000 is fed past the print zone 3000 to the cutting location C where it is supported by facing wall portions on either side of the slot 5400.

The second tape printing device 1000′ includes a cutting mechanism 5600 including a cutter support member 5800 which carries a blade 60000. The blade 60000 cuts the image receiving tape 4000 and then enters the slot 5400. It should be appreciated that the first embodiment will usually also include a cutting mechanism.

In an embodiment of the present invention, a so called tab cut mechanism is provided in conjunction with the full cut mechanism. An example of a tab cut mechanism which may be used in the present invention is described in EP 0711637.

The ink ribbon can be omitted in certain embodiments where the image receiving tape is of a thermally sensitive material. In this case, the image is printed by the thermal print head directly onto the thermally sensitive image receiving tape.

Basic circuitry for controlling the tape printing device 1000 of FIG. 18 or the tape printing device 1000′ of FIG. 19 is shown in FIG. 20. There is a microprocessor chip 100″ having a read only memory (ROM) 102″, a microprocessor 101″ and random access memory capacity indicated diagrammatically by RAM 104″. The microprocessor chip 100″ is connected to receive label data input to it from a data input device such as a keyboard 106. The microprocessor chip 100″ outputs data to drive a display 108 via a display driver chip 109″ to display a label to be printed (or a part thereof) and/or a message for the user. The display driver alternatively may form part of the microprocessor chip. Additionally, the microprocessor chip 100″ also outputs data to drive the print head 1600 so that the label data is printed onto the image receiving tape to form a label. Finally, the microprocessor chip 100″ also controls the motor 7000 for driving the platen. The microprocessor chip 100″ may also control the cutting mechanism 5600 of FIG. 19 or a cutting mechanism of FIG. 18 to allow a length of tape to be cut off. In alternative embodiments at least part of the cutting mechanism may be manually operated. The microprocessor chip 100″ may also control a tab cut mechanism to determine where the tab cuts are made in the tape.

In one embodiment of a printer according to the present invention, the printer comprises a plurality of printing modes, including a self-laminating label mode which may be selected for printing self-laminating labels. On selecting the self-laminating label mode, the user is prompted to enter data for the self-laminating label. This data includes one or more of print character data, print character size, cassette type, tape type, tape width, label dimensions, label length, label width and dimensions of the article to which the label is to be applied including one or more of cable diameter, cable circumference and cable radius. The position of the tab cuts and the final cut may also be entered into the printer by the user along with the other label data prior to printing or may be calculated from the previously mentioned data input. Accordingly, the lengths of the first portion, the second portion, and the third portion can be set according to the circumference of the tube or wire, or size or shape of another article, to which the label is to be applied.

The printer comprises a controller comprising memory. This may be incorporated into the circuitry illustrated in FIG. 20. A user may program templates for defining the dimensions of a label which may be stored in said memory. A template includes the format data for a particular label layout. For example, the label format/dimensions for a particular size of cable. A suitable template may then be selected from the memory, print character data entered into the printer for printing on the printing portion, and then the label is printed. In an embodiment of the invention print character data may also be saved in conjunction with, or separate from, the label format data. The printer may also be provided with a number of pre-programmed templates for self-laminating labels. Alternatively, or additionally, the format/dimensions of the labels (including where any tab cuts are made etc. . . . ) may be based on label data entered manually by a user. Accordingly, a controller is provided which is adapted to format self-adhesive labels.

In a further embodiment of the present invention, a cassette is provided with indication means for indicating the type of tape in the cassette. The printer is provided with means to detect what type of tape is in the printer and alter one or more of the formatting, print character size, printer speed, print/tape width, print height, number of lines of print and other printer variable. The printer variables may also be selected by user input.

Another embodiment of the present invention and a production method therefore will now be described with reference to FIGS. 21 to 24. In this embodiment, a continuous self-laminating label tape has a V-shape. A first portion of the continuous self-laminating label tape is coloured and a second portion is transparent. A section of the continuous self-laminating label tape may be separated from the continuous self-laminating label tape by a cutting operation in order to create a self-laminating label. Such a cutting operation may be performed before or after a printing operation in which an image may be printed on at least a portion of said self-laminating label. FIG. 7 shows a plurality of steps required to apply the self-laminating label to a cable or wire. The method comprises the steps of: (a) separating the folded portions as shown in (b); removing the liner material from the first, second and third portions as shown in (c)—the slit aids in the removal of the liner material; wrapping the label around the wire/cable to adhere the label to the wire/cable and laminate the printed portion as shown in (d). One end of the label, which may be printed, is overlaid with a portion at an opposite end of the label which is not printed. Accordingly, a printed portion at one end of the label is over-laid with an unprinted portion at the opposite end of the same label thus forming a self-laminating label.

FIG. 21 shows a lateral cross section of a label foil 200 comprising a label material 201 and a liner material 202. The label material 201 comprises a transparent PVC material 203. On an underside of the PVC material 203 is an adhesive layer 204. The liner material 202 comprises a PET material 205. A top surface of the PET material 205 abuts the adhesive layer 204; a silicon layer 206 is applied to the top surface of the PET material. On a top surface of the PVC material 203, said top surface being opposite the underside of the PVC material 203, the label material 201 is printed with coloured material 207 to generate coloured zones 212. The coloured zones 212 are substantially linear and extend in a longitudinal direction along the surface of the label foil 200. Lateral and longitudinal directions are defined on a surface of the label foil 200, said surface being parallel to the planes of the individual layers 203 to 205 that comprise the label foil 200.

FIG. 22 shows an alternative label foil 210. In this embodiment, prior to the label material 201 being printed with coloured material 207, the PVC material 203 is coated with a coating 208. The coating 208 improves binding of the coloured material 207 with the PVC material 203. the coloured material 207 may be any colour, including but not limited to one of black, white, red, orange, yellow, green, blue and purple.

FIG. 23 shows 4 stages in the process of producing a self laminating label tape from a label foil 200. The production of the tape starts with a reel of label foil 200. In this example, each coloured zone 212 has a width that is twice the width of the completed self-laminating tape. Separating each coloured zone 212 is a transparent zone 211. In this example, the coloured zones 212 and the transparent zones 211 are of equal widths, where width is measured in a lateral direction on the surface of the label foil 200. However, a zone situated adjacent an edge of the label foil 200 may be of any width. I

n FIG. 23 the zones at each edge of the label foil are shown as being half the width of the other zones. FIG. 23 (a) shows a label foil 200 or 210 as described above with reference to FIG. 21 or 22 respectively.

The liner material 202 is cut along a longitudinal direction of said label foil at a lateral position corresponding to a boundary between each of the coloured and transparent zones. This step is shown in FIG. 23 (b). The liner material 202 and the label material 201 are temporarily separated from each other prior to cutting of the liner material and the layers are brought back together again once the back slit is created. The lateral positions of the cut in the liner material is shown by arrows 213. The separation of the label material 201 and the liner material 202 is preferred due to a difference in hardness between the transparent PVC material 203 and the PET material 205. Attempting to cut through the PET material 205 without separating it from the transparent PVC material 203 may cause damage to the transparent PVC material 203. However, separation may not be necessary in all circumstances. Different materials may not require separation.

After the two layers 201 and 202 are brought back together, the label foil 200 is cut into a plurality of tapes. A full cut is created in the middle of each coloured zone 212 and in the middle of each transparent zone 211. The lateral position of each full cut is shown in FIG. 23 (c) by arrows 214. FIG. 23 (d) shows the label foil after the full cuts have been performed. The full cuts separate the label foil into a plurality of tapes 215, each tape 215 comprises a length of continuous self-laminating tape with a coloured zone equal to the transparent zone and a longitudinal cut or slit in the liner material 202 situated in the middle of the tape.

FIG. 24 shows a subsequent stage in the production process, wherein the width (as measured in the lateral direction) of the continuous self-laminating tape is reduced by half by folding the tape 215 along its length along the slit, with two exposed surfaces of the liner material 202 facing each other, wherein one exposed surface of the liner material lies opposite to the transparent zone 211, and the other exposed surface of the liner material lies opposite to the coloured zone 212. The folds are flattened by locally heating the material where the folds are to be applied prior to folding, and by applying a relatively high pressure to opposite sides of the folded material. The heating and the pressure in combination with the slit in the liner material 202, the memory effect of the label material, and the thinness of the materials allow the manufacture of a folded continuous tape as shown in FIG. 24 (c) that is suitable for coiling and transporting in a tape cassette.

During manufacture, the PET material 205 of the label foil 200 or 210 may be printed with at least one graphic. Said graphic may comprise at least one of: instructions to an end user; an indicia of label tape properties; an indicia of label tape origin; decoration; and any other graphic design.

In an alternative embodiment of the present invention, the coloured zone 212 of the self-laminating label tape is ⅓ the width of the label 215 instead of ½ as shown in FIGS. 23 and 24. Further, the tape is folded twice, in a “Z” shape instead of once, in a “V” shape as described above. Instead of labels with ½ coloured and ½ transparent, these labels are ⅓ coloured and ⅔ transparent. The arrangement of such a label tape is shown in cross section in FIG. 5, and is described above.

A label printer may be arranged to print onto both “Z” and “V” folded continuous self-laminating tape, such a label printer may be comprise detection means to detect which kind of continuous self-laminating tape is present in the tape printer. Such a detection means may comprise a plurality of push switches that interface with a respective plurality of holes or blanks or combination thereof situated on the tape cassette housing. Alternatively, such detection means may comprise the use of Radio Frequency Identity (RFID) tags detector for detecting an RFID tag incorporated into a tape cassette at manufacture, wherein the RFID tag comprises information about the characteristics of a label tape in the cassette. It is envisaged that any other detection means known to a person skilled in the art may be incorporated into a printer and cassette.

The present invention provides a low cost solution while still achieving highly professional self-laminating labels. While embodiments of the invention have been described in relation to applying labels to wires and cables, it is envisaged that labels produced according to the present invention may be applied to other articles of various shapes and sizes. While this invention has been particularly shown and described with reference to preferred embodiments, it will be understood by those skilled in the art that various changes in form and details may be made therein without departing from the scope of the invention as defined by the appending claims.

1. A roll of tape for use in a tape printing apparatus for producing labels, whereby in use an unprinted portion of said tape overlays a printed portion of said tape thereby forming a laminated label, said tape comprising a layer of label material, a layer of removable liner material, and an adhesive layer disposed between said label material and said liner material, wherein said tape comprises at least one fold with the tape being folded back on itself in a width-wise direction, said tape having first and second overlapping portions, wherein said first portion has an outer surface arranged for printing thereon.

2. A roll of tape as claimed in claim 1, wherein said outer surface of said first portion comprises an ink coating.

3. A roll of tape as claimed in claim 1 or claim 2, wherein said label material is continuous.

4. A roll of tape as claimed in any preceding claims, wherein said liner material comprises at least two portions with a slit positioned therebetween at said at least one fold.

5. A roll of tape as claimed in any preceding claim, wherein said liner material comprises memory effect material.

6. A roll of tape as claimed in any previous claim, wherein said tape comprises a single fold whereby said tape is folded into a V-form having two overlapping portions.

7. A roll of tape as claimed in any one of claims 1 to 5, wherein the said tape comprises two folds whereby said tape is folded into a Z-form having three overlapping portions.

8. A roll of tape as claimed in any previous claim, wherein said overlapping portions are equal in width.

9. A roll of tape as claimed in any previous claim, wherein said label material comprises a transparent material.

10. A roll of tape as claimed in any previous claim, wherein said label material comprises a clear material.

11. A roll of tape as claimed in any previous claim, wherein said label material is a polyethylene, polyester, polyethylene terephthalate or polyvinyl chloride material.

12. A roll of tape as claimed in as claimed in any previous claim, wherein said liner material is a transparent, opaque, clear or coloured material.

13. A roll of tape as claimed in any previous claim, wherein said liner material is a polyethylene, polyester, polyethylene terephthalate or polyvinyl chloride material.

14. A roll of tape as claimed in any previous claim, wherein said tape is folded over the entire length of the tape.

15. A roll of tape as claimed in any previous claim, wherein the label material is a direct thermal printing material.

16. A roll of tape as claimed in any previous claim, wherein a slit is provided in said liner material of said first portion of tape thereby defining a portion of tape between a first end of said tape and a portion to be printed.

17. A roll of tape for use in a tape printing apparatus for producing labels, whereby in use an unprinted portion of said tape overlays a printed portion of said tape thereby forming a laminated label, said tape comprising a label layer, a liner layer, and an adhesive layer disposed therebetween, said label layer comprising a transparent material and said liner layer comprising a removable layer of transparent or non-transparent material.

18. A roll of tape as claimed in claim 17, wherein said label layer comprises a clear material.

19. A roll of tape as claimed in claim 17 or claim 18, wherein said label layer comprises a polyethylene, polyester, polyethylene terephthalate or polyvinyl chloride material.

20. A roll of tape as claimed in any one of claims 17 or 19, wherein said liner layer comprises a polyethylene, polyester, polyethylene terephthalate or polyvinyl chloride material.

21. A roll of tape as claimed in any one of claims 17 to 20, wherein said liner layer has a plurality of cuts therein defining a first portion, a second portion for printing thereon, and a third portion.

22. A roll of tape as claimed in any one of claims 17 to 20 wherein said liner layer has as least one cut therein defining a first portion for printing thereon and a second portion.

23. A roll of tape as claimed in any previous claim, wherein said label layer has a clear zone and a coloured zone.

24. A roll of tape as claimed in claim 23, wherein said coloured zone comprises an ink coating.

25. A tape cassette for use in a tape printing apparatus, said tape cassette comprising a body housing a roll of tape according to any previous claim.

26. A tape printer comprising a tape receiving portion for receiving a roll of tape, a print head comprising a plurality of printing elements for printing an image on a tape, a drive means for driving a tape past the print head, a cutting mechanism for cutting a tape, and a control means, said control means being adapted to control the plurality of printing elements, the drive means and the cutting mechanism to produce a label having a printed portion and an unprinted portion for overlaying the printed portion to produce a laminated label.

27. A tape printer according to claim 26, wherein the said control means is adapted to receive information and to format a label according to said information whereby the dimensions of the printed portion and the non-printed portion of the label are defined according to said information.

28. A tape printer according to claim 26 or claim 27, wherein said cutting mechanism comprises a tab-cut mechanism for cutting through at least one layer, but not all the layers, of a multi-layer tape.

29. A tape printer according to claim 28, wherein said control means is adapted to control said tab-cut mechanism to produce a label having two tab cuts defining a first and second unprinted portion with a printed portion therebetween or to produce a label having one tab cut defining a first printed portion and a second unprinted portion.

30. A tape printer according to any one of claims 26 to 29, wherein said printer comprises a plurality of print modes including a mode for producing self-laminating labels.

31. A label comprising a label layer, a liner layer, and an adhesive layer disposed therebetween, said label having a first unprinted portion, and a printed portion, wherein print is disposed on an outer surface of said label layer in said printed portion, said liner layer being removable from at least said unprinted portion, wherein said first unprinted portion and said printed portion are arranged whereby in use said unprinted portion can overlay said printed portion to thereby form a laminated label.

32. A label according to claim 31, wherein said label comprises a second unprinted portion with the printed portion disposed between the unprinted portions, said liner layer being removable from both the unprinted portions.

33. A label according to claim 31 or claim 32, wherein said outer surface of said printed portion comprises an ink coating.

34. A label according to any one of claims 31 to 33, wherein the liner layer is retainable in said printed portion whereby in use said retainable liner layer provides a background to said print.

35. A label according to any one of claims 31 to 34, wherein said label layer comprises a transparent material and said liner layer comprises a non-transparent material.

36. A label according to any one of claims 31 or 35, wherein a cut is provided in said liner layer between said first unprinted portion and said printed portion.

37. A label according to claim 36, wherein a further cut is provided in said liner layer between said printed portion and said second unprinted portion.

38. A label comprising a label layer, a liner layer, and an adhesive layer disposed therebetween, said label having a first unprinted portion and a printed portion, wherein print is disposed on an outer surface of said label layer in said printed portion, said label layer being removable from said first unprinted portion and said label layer being retainable on said liner layer in said printed portion.

39. A label according to claim 38, said label comprising a second unprinted portion with said printed portion being disposed between said first and second unprinted portions, said label layer being removable from said first and second unprinted portions.

40. A label according to claim 38, wherein said first unprinted portion and said printed portion are arranged whereby in use said unprinted portion can overlay said printed portion to thereby form a laminated label.

41. A method of manufacturing a tape for a label printing apparatus for producing labels, said method comprising the steps of:
(a) constructing a layered sheet;
(b) folding the layered sheet one or more times in the width-wise direction along the length of the sheet;
(c) compressing the folded sheet to form a folded multi-layered tape.

42. A method according to claim 41, wherein the layered sheet is cut into a plurality of layered sheets prior to said folding step.

43. A method according to claim 41 or claim 42, wherein the layered sheet comprises a layer of label material, a layer of liner material, and a layer of adhesive material disposed therebetween.

44. A method according to any one of claim 41 to claim 43, further comprising the step of winding the folded multi-layered tape into a roll.

45. A method according to claim 43, wherein a slit is made in the liner material at one or more positions where the folds are to be applied.

46. A method according to claim 45, wherein the liner material is separated from the label material prior to a slit being made in the liner material.

47. A method according to claim 41, further comprising the step of incorporating the roll of folded multi-layered tape into a cassette for a label printing apparatus.

48. A method according to any one of claims 41 to 47, wherein said sheet is heated where the one or more folds are to be applied prior to, and/or during, folding.

49. A method according to claim 43, where the label material is slit at one or more positions where the folds are to be applied.

50. A method according to any one of claim 41 to claim 49, wherein at least one coloured zone is printed on said layered sheet.

51. A method according to claim 50, wherein a coating is applied to said layered sheet prior to the printing of at least one coloured zone.

52. A method according to claim 50 or claim 51, when dependent on claim 44, wherein said slit is applied at a position adjacent to a long boundary of said at least one coloured zone.

53. A method according to any one of claim 50 to claim 52, wherein at least one cut is used to separate said layered sheet into a plurality of layered tapes, said cut applied at a centre line of said at least one coloured zone, said centre line being parallel to a long axis of said coloured zone and spaced equally from each long boundary of said coloured zone.

54. A method of labelling an article comprising: using the roll of tape according to any one of claims 1 to 15 to produce a printed label; removing the liner layer from the label layer; wrapping the printed label layer around the article whereby the adhesive layer bonds the label layer to the article and whereby the unprinted portion overlays the printed portion to form a laminated label.

55. A method of labelling an article comprising: using the roll of tape according to claim 16 to produce a printed label; removing the liner layer from the portion of tape between the first end and the slit in the first portion of tape and removing the liner layer from the second portion of tape while retaining the liner layer in the printed portion of tape; wrapping the printed label layer around the article whereby the adhesive layer bonds the label layer to the article and whereby the unprinted portion overlays the printed portion to form a laminated label.

56. A method of labelling an article comprising: printing a tape having a label layer, a liner layer and an adhesive layer disposed therebetween to produce a printed portion with print on the label layer of the printed portion; providing a tab-cut in the liner layer either side of the printed portion and a full cut though all the layers at a distance D from the printed portion so as to produce a label having a first unprinted portion and a second unprinted portion with the printed portion disposed therebetween; removing the liner layer from the first and second unprinted portions while retaining the liner layer in the printed portion of tape; wrapping the label layer around the article whereby the adhesive layer bonds the label layer to the article and whereby the unprinted portion overlays the printed portion to form a laminated label.

57. A method of labelling an article comprising: mirror printing a tape having a label layer, a liner layer and an adhesive layer disposed therebetween to produce a printed portion with mirror print on the label layer of the printed portion; providing a tab-cut in the label layer either side of the printed portion and a full cut though all the layers at a distance D from the printed portion so as to produce a label having a first unprinted portion and a second unprinted portion with the printed portion disposed therebetween; removing the label layer from the first and second unprinted portions while retaining the label layer in the printed portion of tape; applying the label to the article whereby the adhesive layer bonds the label layer to the article and whereby the liner layer overlays the printed portion to form a laminated label.

58. A method of labelling an article comprising: printing a tape having a label layer, a liner layer and an adhesive layer disposed therebetween to produce a printed portion with print on the label layer of the printed portion; providing a tab-cut in the label layer on one side of the printed portion and a full cut though all the layers at a distance D from the printed portion so as to produce a label having a printed portion and an unprinted portion with the tab-cut therebetween; removing the label layer from the unprinted portion while retaining the label layer in the printed portion of tape; wrapping the label around the article whereby the adhesive layer bonds the label layer to the article and overlays the printed portion with the printed portion extending radially from the article.
